(19) United States
(12) Patent Application Publication
(10) Pub. No.: US 2011/0091849 A1
(43) Pub. Date: Apr. 21, 2011

(54) Sport leagues formation eligibility and rules.

(76) Inventor: Ulric Alturo Todman, New York, NY (US)

(21) Appl. No.: 12/545,756

(22) Filed: Oct. 13, 2009

(51) Int. Cl. G09B 19/00

(52) U.S. Cl. 434/247

(57) ABSTRACT

1) Athlete must be over the age of 21, this is because we believe that the league should not discourage him for pursuing an education with the prospect of making money.

2) Players are to be chosen by general announcement to the public and tryouts are open.

3) The athlete eligibility will be base on where his roots are. The athlete will have to reside in the city/region for 3 years and prove his or her residency. The 3 years rule because many players might change residency while attending school or might moved as an adult.

4) The player will have to commit to the team in the closest city/team, in which he resides. Once committed he cannot pay for any other team. A player can try out for a team for the period of 5 years.

5) Eligibility is for 3 years once he makes the team, and is limited to any who has no played or been on any professional roster for 366 days and has not be on the NBA, MLB, NFL for longer than 3 calendar years.

6) Once a player tries out and makes a team, he can only play in the league for 3 years. If a play is dropped from a team, he is limited to play only for the 2 years of his eligibility.

7) There is no switching or being traded to another team or moving to another city to be eligible.

8) All player in the league “base” salaries are to be equal, Further compensation is to base on the teams performance. With the League champions being rewarded equally for their efforts.

9) Each year teams with winning records will be required rotate ⅓ of players off of the team and draw on new talent to fill their roster.

10) A team with a losing record (not making the playoffs) can replace the entire team if they so choose.

This for a Utility patent for a new way of organizing a sport league, i.e. basketball, baseball, football, etc. a way to have more professional sports teams as well as promoting more interest in sports. This concept is to have true competition between City/region of homegrown or “transplanted talent” (If an athlete for the purpose of going to school or work moves) that will be true rivalries to see which city/regions develop the best talent in sports, such as basketball, baseball, football, etc and to developed leagues. Our eligibility will be different to allow as many athletes to be able to have an opportunity to get a payday as well as to display their talent on possible on a national stage.

An athlete (basketball player) can try out for a team if he has roots (attended school, grew up) within a specified distance of that community and has been a resident of that community for at least 3 years. Once a player commits to play for a city or team, he cannot claim the rights to be a member of another city or team and his eligibility is for three years. There is no such thing as trades or switching teams. The longest a player can play for a team is 3 years. At the end of the three years he will be rotated out. Each year the teams will have a new round of tryouts opens to athletes locally and region of players of that area. A team with a losing record can replace the whole team; a champion team would have to rotate with each player playing a maximum of 3 seasons. Each team will have twelve players. From 21 years to 27 years of age. A panel of sport writers and sponsors in the city or area of play will pick the Coach. An athlete (basketball player) can try out for a team if he has roots (attended school, grew up) within a specified distance of that community and has been a resident of that community for at least 3 years. Once a player commits to play for a city or team, he cannot claim the rights to be a member of another city or team and his eligibility is for five years. That means he can only tryout for a team for five years whether he makes or not. There is no such thing as trades or switching teams. The longest a player can play for a team is 3 years. At the end of the three years he can be rotated out. Each year the teams will have a new round of tryouts. A team with a losing record can replace the whole team; a champion team would have to rotate with each player playing a maximum of 3 seasons. Each team will have twelve players. From 20 years to 27 years of age.

What is claimed is:

1. Creation and formation of professional sport leagues with a reason for being, not just a developmental league for major sport league, such as the NFL, NBA, or MLB, or a minor league team. A league that has a sense or purpose other than assembling a team of players of the best that money can buy. To have them represent a city or region that they are a part of, grew in, went to school in, have roots in. A city or region that fans, friends and family have pride of being a part of and will represent their community as a group for that area to find out which community develop the best athletes wholly representing them and to prove the area of the country where these player come from. From marketing prospective each community will find it necessary to support their homegrown talent.

2. The formation of a sport league with this format will mean that city or region will vie for sponsorship for their home talent to compete against other areas to see who produce the best talent or athletes. Athletes will be limited to 3 years of service. This would mean a greater number of athletes would have a chance to perform and compete. Any city with the right combination of athletes could win a championship in any of their chosen sports.

3. Athlete would pledge to a team based of their residency or the area where they went to school. They would be limited to 3 years of tryouts, as well as 3 years eligibility. Once an athlete pledge to a particular city or team, the player cannot play for any other team. This will give the league a homegrown flavor, and will create a real competitive spirit, true rivalries amongst the cities.

4. Cities or regions will feel a necessity to join in this competitive environment and support their home grown and local athlete.

5. This format and organization of this league will eliminate the need for teams to go out and find and sign an athlete to a high signing contract in order to gain legitimacy as a professional league.

6. An athlete can choose to play for a team in the city or state he or she lives in, or a certain distant as prescribe by the league.

7. It will much easier to get sponsor for a professional sport team that is comprised of athletes that has been part of the community for most of their lives.

8. Homegrown athletes already have the support of the community as amateur athlete so they will already have a degree of fan loyalty as professional athlete.

9. This system of organizing professional sports will not be limited to baseball, basketball, football, but will include all competitive team sports, and by it nature, Athletes being paid and being able to gain fan loyalty will not be considered a minor or developmental league.
